(19) United States
(12) Patent Application Publication
(10) Pub. No.: US 2017/0265042 A1
(43) Pub. Date: Sep. 14, 2017

(54) METHODS AND APPARATUSES FOR INDOOR POSITIONING

(71) Applicant: Samsung Electronics Co., Ltd., Gyeonggi-do (KR)

(72) Inventors: Seung-won CHOI, Gyeonggi-do (KR); Seong-wook Song, Seoul (KR); Jong-han Lim, Seoul (KR)

(21) Appl. No.: 15/455,960

(22) Filed: Mar. 10, 2017

(30) Foreign Application Priority Data
Mar. 10, 2016 (KR) 10-2016-0029100
Jul. 26, 2016 (KR) 10-2016-0094829

(51) Int. Cl. H04W 4/04; H04W 4/02

(52) U.S. Cl. CPC H04W 4/04; H04W 4/025; H04W 88/02

(57) ABSTRACT

Methods and apparatuses for managing wireless signal information for positioning a mobile terminal are provided. The wireless signal information obtained by measuring a signal characteristic with respect to access points of a target area, is stored in a database. At least one piece of position error information calculated based on the wireless signal information is received from at least one mobile terminal. A positioning reliability is assessed with respect to the target area, based on the at least one piece of position error information. It is determined whether to update the wireless signal information, based on the assessed position reliability.

### PRIORITY

This application claims priority under 35 U.S.C. 119(a) to Korean Patent Application No. 10-2016-0029100, filed in the Korean Intellectual Property Office (KIPO) on Mar. 10, 2016, and Korean Patent Application No. 10-2016-0094829, filed in the KIPO on Jul. 26, 2016, the disclosures of which are incorporated herein by reference.

### BACKGROUND

1. Field

The present disclosure relates generally to indoor mobile terminal positioning, and more particularly, to an indoor positioning system for positioning a mobile terminal in an environment in which positioning using an artificial satellite is difficult, a server of the indoor positioning system, and an operating method thereof.

2. Description of Related Art

A method of locating a position of a wireless terminal by using a global positioning system (GPS) has been used. However, the intensity of a satellite signal may be low, or may not be received in an indoor region, such as, for example, the inside of a building, underground, a tunnel, etc. Thus, it may be difficult to determine an accurate location of a mobile terminal in an indoor region. In attempts to solve problems relating to indoor positioning using the satellite signal, methods have been presented in which a position of a mobile terminal is located by using a signal characteristic obtained from an access point in a wireless communication system, such as, for example, radio frequency identification (RFID), Bluetooth, wireless local area networks (WLAN), etc.

### SUMMARY

An aspect of the present disclosure is to provide an indoor positioning system that determines whether to update a database for positioning via crowdsourcing, a server of the indoor positioning system, and operating methods of the indoor positioning system and the server of the indoor positioning system.

Another aspect of the present disclosure is to provide an indoor positioning system that determines the reliability of positioning with respect to each of a plurality of areas, and updates a database for positioning with respect to an area having low reliability, via crowdsourcing, a server of the indoor positioning system, and operating methods of the indoor positioning system and the server of the indoor positioning system.

According to an aspect of the present disclosure, a method of managing wireless signal information for positioning a mobile terminal, via a server, is provided. The wireless signal information obtained by measuring a signal characteristic with respect to access points of a target area, is stored in a database. At least one piece of position error information calculated based on the wireless signal information is received from at least one mobile terminal. A positioning reliability is assessed with respect to the target area, based on the at least one piece of position error information. It is determined whether to update the wireless signal information, based on the assessed position reliability.

According to another aspect of the present disclosure, an operating method of a positioning server is provided. At least one signal characteristic measurement value is received from at least one mobile terminal located in a target area. At least one piece of position error information is calculated with respect to the at least one mobile terminal based on the at least one signal characteristic measurement value and wireless signal information stored in a database. A positioning reliability is assessed with respect to the target area based on the at least one piece of position error information. It is determined whether to update the database based on the assessed positioning reliability.

According to another aspect of the present disclosure, an operating method of a mobile terminal is provided. A request for position error information is received from a server. Signal characteristics are measured with respect to one or more access points detected by the mobile terminal from among a plurality of access points in a target area. The position error information is calculated based on the measured signal characteristics. The position error information is transmitted to the server

### BRIEF DESCRIPTION OF THE DRAWINGS

The above and other aspects, features, and advantages of the present disclosure will be more apparent from the following detailed description when taken in conjunction with the accompanying drawings in which:

FIG. 1 is a diagram illustrating an indoor positioning system, according to an embodiment of the present disclosure;

FIG. 2 is a flowchart illustrating an operating method of an indoor positioning system, according to an embodiment of the present disclosure;

FIG. 3 is a block diagram illustrating a server, according to an embodiment of the present disclosure;

FIG. 4 is a block diagram illustrating a mobile terminal, according to an embodiment of the present disclosure;

FIG. 5 is a flowchart illustrating an operation of a server and a mobile terminal, according to an embodiment of the present disclosure;

FIG. 6A is a flowchart illustrating an operation of a mobile terminal, according to an embodiment of the present disclosure;

FIG. 6B is a flowchart illustrating an operation of a server, according to an embodiment of the present disclosure;

FIG. 7A is a flowchart illustrating an operation of a mobile terminal, according to an embodiment of the present disclosure;

FIG. 7B is a flowchart illustrating an operation of a server, according to an embodiment of the present disclosure;

FIGS. 8A and 8B are diagrams illustrating an accuracy of a located position according to a sample standard deviation;

FIG. 9 is a flowchart illustrating an operating method of a mobile terminal, according to an embodiment of the present disclosure;

FIG. 10A is a flowchart illustrating an operation of a mobile terminal, according to an embodiment of the present disclosure;

FIG. 10B is a flowchart illustrating an operation of a server, according to an embodiment of the present disclosure;

FIG. 11A is a flowchart illustrating an operation of a mobile terminal, according to an embodiment of the present disclosure;

FIG. 11B is a flowchart illustrating an operation of a server, according to an embodiment of the present disclosure;

FIG. 12 is a flowchart illustrating an operation of a server and a mobile terminal, according to an embodiment of the present disclosure;

FIG. 13 is a flowchart illustrating an operating method of an indoor positioning system, according to an embodiment of the present disclosure;

FIG. 14 is a diagram illustrating the operating method of the indoor positioning system of FIG. 13, according to an embodiment of the present disclosure; and

FIG. 15 is a diagram illustrating a structure of a service system providing a location-based service to a user, according to an embodiment of the present disclosure.

### DETAILED DESCRIPTION

Embodiments of the present disclosure are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present disclosure.

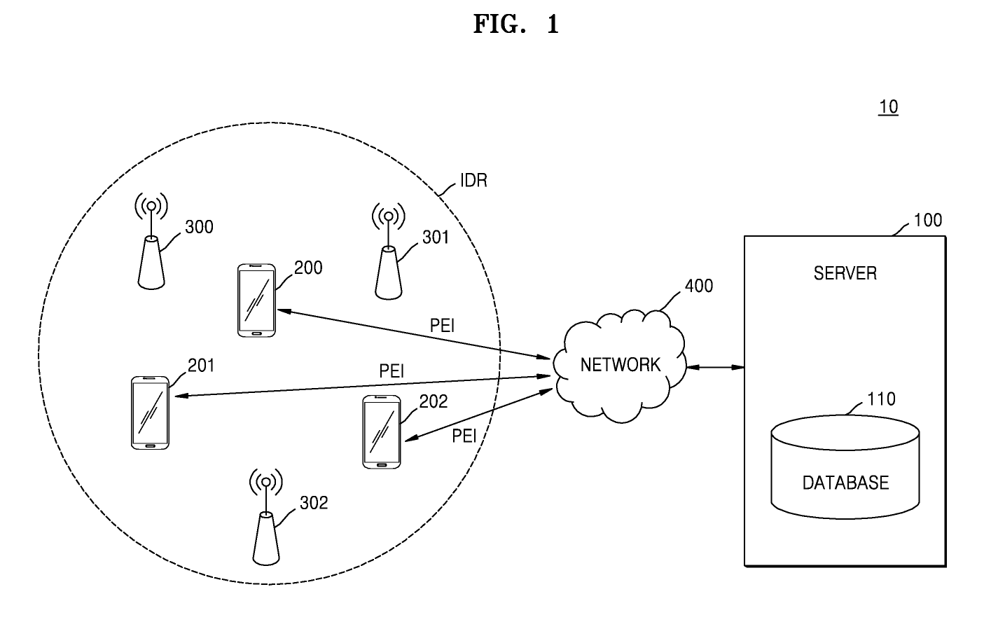

FIG. 1 is a diagram illustrating an indoor positioning system, according to an embodiment of the present disclosure.

Referring to FIG. 1, an indoor positioning system 10 includes a server 100, at least one mobile terminal 200, and a plurality of access points 300, 301, and 302. The indoor positioning system 10 further includes a network 400. FIG. 1 illustrates an example in which the indoor positioning system 10 includes three mobile terminals 200, 201 and 202, that is, first through third mobile terminals 200, 201 and 202, and three access points 300, 301 and 302, that is, first through third access points 300, 301, and 302. However, the present disclosure is not limited thereto. The number of mobile terminals and the number of access points may vary, and may change over time.

The access point 300 is a device for transmitting or receiving wireless signals for near-field communication. For example, the near-field communication may include a wireless local area network (WLAN), ultra wideband (UWB), Bluetooth, worldwide interoperability for microwave access (WiMax), wireless broadband (WiBro), delivery traffic indication message (DTIM), and a hot spot. The access points 301 and 302 are substantially equal to the access point 300. Accordingly, the descriptions of the access point 300 may be applied to the access points 301 and 302. According to embodiments of the present disclosure, the first through third access points 300, 301, and 302 may be devices based on homogeneous or heterogeneous near-field communication. For example, all of the first through third access points 300, 301, and 302 may be communication devices based on WLAN. As another example, the first access point 300 may be a communication device based on WLAN, and the second access point 301 and the third access point 302 may be communication devices based on Bluetooth.

The access point 300 may transmit a wireless signal to the mobile terminal 200. The wireless signal may include identification information of the access point 300. The identification information of the access point 300 is information necessary for identifying each of the access points, and may include a media access control (MAC) address, service set identification (SSID), etc. The wireless signal may further include other information.

The mobile terminal 200 may measure a signal characteristic of the wireless signal received from the access point 300 arranged in a target area IDR. For example, the mobile terminal 200 may measure a signal characteristic of at least one wireless signal received from at least one adjacent access point from among the first through third access points 300, 301, and 302 of the target area IDR. The signal characteristic may include received signal strength indication (RSSI), round trip time (RTT), etc. of the received signal. However, the signal characteristic is not limited thereto, and may further include various other indicators about the wireless signal. Hereinafter, for convenience, descriptions will be made assuming that the signal characteristic is RSSI.

The mobile terminal 200 may transmit the measured signal characteristic to the server 100 and receive from the server 100 position information estimated based on the signal characteristic. According to another embodiment, the mobile terminal 200 may locate the position thereof based on the measured signal characteristic. The mobile terminal 200 may receive from the server 100 reference information for locating a position, and locate the position based on the measured signal characteristic. The mobile terminal 200 may transmit or receive data to and from the server 100 via the network NT. The network NT may include a WLAN, such as wireless fidelity (Wi-Fi) and ZigBee, a broadband network, such as a wireless metropolitan area network (MAN), and a mobile cellular network, such as 3^{rd} generation (3G), 4^{th} generation (4G), and long term evolution (LTE). The server 100 may locate a position of the mobile terminal 200 and provide the located position to the mobile terminal 200. The server 100 may locate the position of the mobile terminal 200 based on the RSSI received from the mobile terminal 200 and wireless signal information stored in a database 110. The wireless signal information may include reference information for locating a position in the target area IDR. For example, the wireless signal information may include measured values of wireless signals received from the first through third access points 300, 301, and 302, or data calculated based on the measured values of the wireless signals. For example, the wireless signal information may include RSSI values with respect to the first through third access points 300, 301, and 302, which are measured at a plurality of reference points of the target area IDR. According to embodiments, the wireless signal information may be stored in the database 110 as a data map type.

The mobile terminal 201 and 202 are substantially equal to the mobile terminal 200. Accordingly, the descriptions of the mobile terminal 200 may be applied to the mobile terminals 201 and 202.

The server 100 may provide the wireless signal information to the mobile terminal 200. As described above, the mobile terminal 200 may locate the position thereof based on the wireless signal information and the measured signal characteristic. For example, when the mobile terminal 200 enters into the target area IDR, the server 100 may provide the wireless signal information with respect to the target area IDR, stored in the database 110, to the mobile terminal 200. The mobile terminal 200 may measure a signal characteristic of the wireless signal received from at least one adjacent access point 300, and compare the signal characteristic with the wireless signal information to locate the position thereof.

The server 100 may be a server managed by a service operator (for example, a mobile communication operator, a location-based service operator, a location positioning service provider, etc.) or an owner of a building in which the target area IDR is located. However, the server 100 is not limited thereto. The server 100 may be realized inside the mobile terminal 200. The server 100 may be a positioning server providing position information. The server 100 may locate the position of the mobile terminal 200 by using a non-parametric approach or a parametric approach.

The non-parametric approach is a method that does not involve the use of a parameter, and for example, may include a fingerprint method. The fingerprint method is a method according to which a plurality of reference points is set at the same interval in an area in which the position is to be located. A fingerprint of a signal received from an access point adjacent to each of the reference points, that is, a signal characteristic, is stored in a database. In a positioning phase, a fingerprint of a signal received from an access point is compared with the fingerprint stored in the database so that the reference point, in which the fingerprint stored in the database has the most similar characteristics to the fingerprint of the received signal, is located as the position of the mobile terminal.

The parametric approach is a method of parametrizing a system and using the parametrized system. For example, the parametric approach may include a method using a pathloss model (also referred to as a signal propagation model). The pathloss model indicates a characteristic that power of a received signal reduces depending on a transmission distance and may be represented as shown in Equation (1).

$${P}_{S} = {P}_{0} - 10 {βlog}_{10} ( \frac{d}{{d}_{0}} ) + X = α - 10 β {log}_{10} ( d ) + X \qquad ( 1 )$$

Here, P_{R} indicates an RSSI value of a received signal, d indicates a distance between a mobile terminal and an access point, X indicates Gaussian noise having an average value of 0, and P₀ indicates an RSSI value of the received signal when a distance between a transmitting point of the signal and a receiving point of the signal is d₀.

For example, when the server 100 locates the position of the mobile terminal 200 according to the fingerprint method, the server 100 may compare a signal characteristic (for example, an RSSI value measured in the mobile terminal 200) received from the mobile terminal 200 with a signal characteristic (for example, an RSSI value measured in advance at each reference point of the target area IDR via a training phase) stored in the database 110, and may locate the position of the mobile terminal 200 as the reference point having the most similar signal characteristic value to the received signal characteristic.

The indoor positioning methods described above require a training phase before the locating of a position. For example, the training phase includes measuring a signal characteristic observed at an access point adjacent to each reference point of an area in which the position is to be located, and storing wireless signal information of the area based on the measured signal characteristic in a database.

However, even after the database is established through the training phase, the wireless environment changes from its state during the training phase, due to various reasons, such as removal, shifting, or breakdown of access points over time, and thus, training has to be performed again with respect to corresponding areas. Therefore, in order to maintain constant quality of service of indoor positioning, the training phase has to be regularly performed with respect to each area. However, the regular training phase is time consuming and expensive.

The indoor positioning system 10 may assess a positioning reliability of the target area IDR via crowdsourcing, and based on a result of the assessment, may determine whether to perform re-training, that is, whether to update the wireless signal information stored in the database 110.

To this end, the mobile terminal 200, according to an embodiment of the present disclosure, may transmit position error information (PEI) based on a located position thereof to the server 100. For example, at least one of the plurality of mobile terminals 200, 201, and 202 may transmit the PEI to the server 100. According to another embodiment, the server 100 may calculate the PEI of the mobile terminal 200 based on the signal characteristic received from the mobile terminal 200.

For example, the PEI may include a signal propagation model error or a standard deviation of position samples (hereinafter, referred to as sample standard deviation). Also, the PEI may include various calculation values or indices calculated based on the signal propagation model error or the sample standard deviation.

The signal propagation model error indicates a difference between a signal characteristic value estimated by using the pathloss model and a measured signal characteristic value. For example, the signal characteristic may be RSSI. When an access point is moved or removed, a difference between an estimated RSSI value and a measured RSSI value increases, and thus, a value of the signal propagation model error increases. Thus, the signal propagation model error is an index for easily detecting a change in the wireless environment.

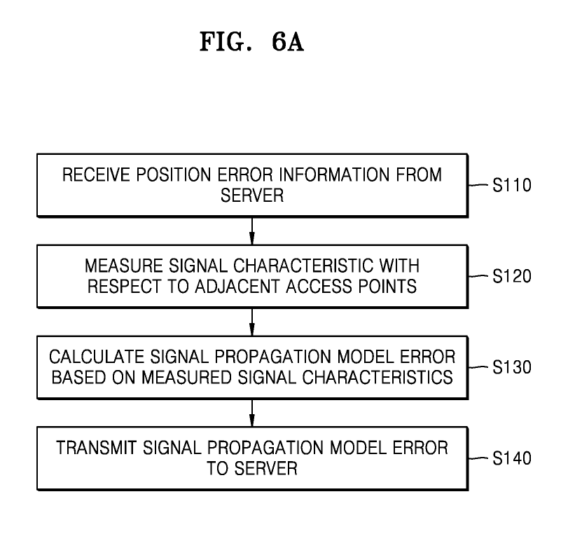

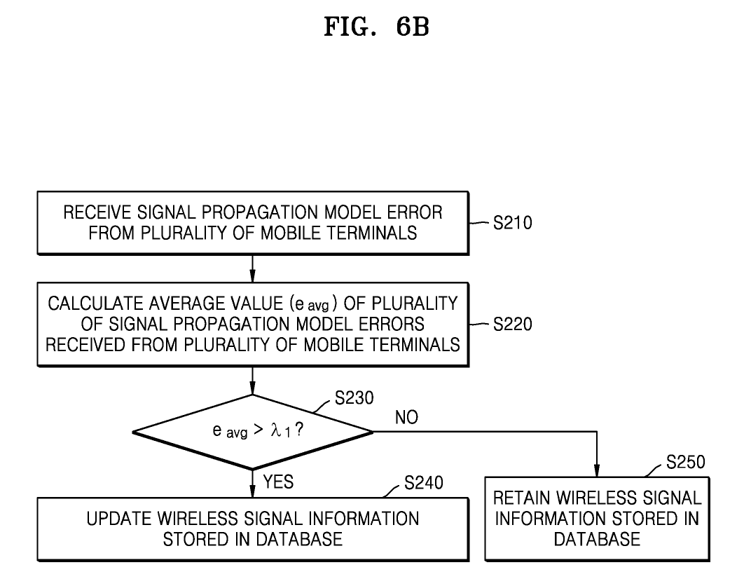

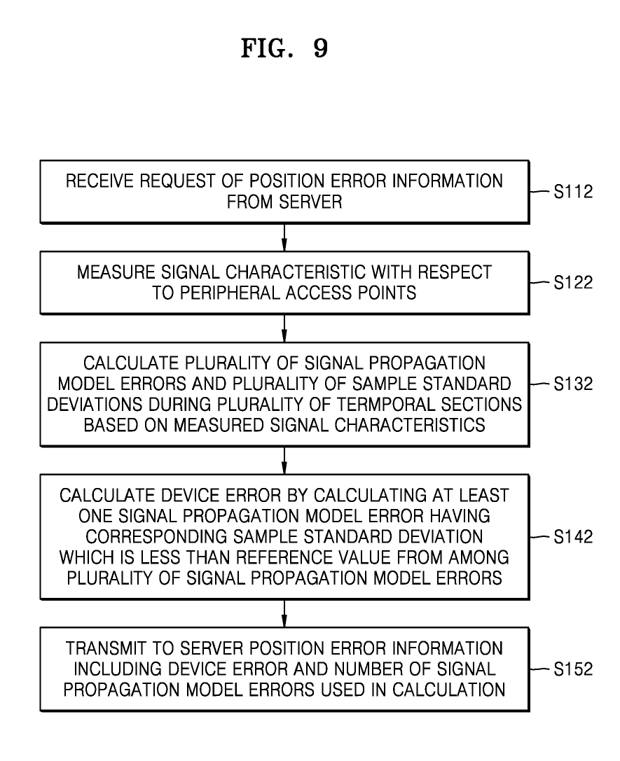

The sample standard deviation denotes a standard deviation of a plurality of candidate position samples in which the mobile terminal 200 may be located. The candidate positions may be positions corresponding to the reference points stored in the database 110. Alternatively, the candidate positions may be positions randomly determined according to specific conditions. For example, the candidate positions may be determined according to the RSSI value measured in the mobile terminal 200. Since the standard deviation with respect to the candidate positions increases in a position in which the positioning reliability is low, the sample standard deviation also increases in the position. Thus, the sample standard deviation is an index for easily determining the reliability of the currently located position. The sample standard deviation may have a large value in a position in which positioning is not accurately performed. When there is a big change in the wireless environment due to shifting or removal of an access point, the sample standard deviation with respect to all locations of the target area IDR may increase. The signal propagation model error and the sample standard deviation will be described in greater detail below with reference to FIGS. 6A and 9.

The server 100 may assess the positioning reliability of the target area IDR based on the PEI. Based on a result of the assessment, the server 100 may determine whether to update the wireless signal information stored in the database 110. That is, the server 100 may determine whether re-training is necessary with respect to the target area IDR, based on the PEI.

As described above, the PEI may include the signal propagation model error, the sample standard deviation, or the like, and when a change in the access points in the target area IDR increases, the signal propagation model error and the sample standard deviation may increase. Thus, the server 100 may assess the positioning reliability of the target area IDR based on the PEI. When it is determined that the positioning reliability is low, the server 100 may determine that re-training with respect to the target area IDR is necessary for an update of the wireless signal information.

As described above, the indoor positioning system 10 may assess the positioning reliability via crowdsourcing, and may determine whether to perform re-training based on a result of the assessment. Thus, unnecessary re-training may be prevented, and time and expenses for re-training may be reduced.

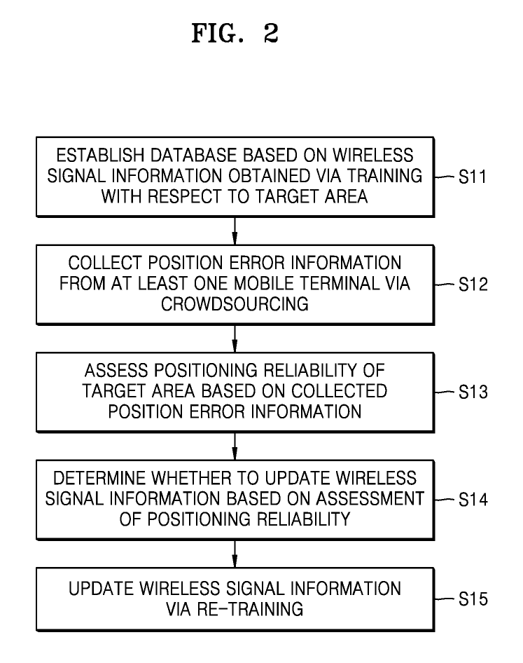

FIG. 2 is a flowchart illustrating an operating method of an indoor positioning system, according to an embodiment of the present disclosure. In detail, FIG. 2 illustrates a process of establishing and updating a database of the indoor positioning system. Each of the operations of FIG. 2 may be performed in the indoor positioning system 10 of FIG. 1.

Referring to FIG. 2, the indoor positioning system establishes a database based on wireless signal information obtained via training with respect to a target area, in operation S11. The training may be performed online or offline. A server may store the wireless signal information obtained via training in the database. For example, when the training is performed offline, an engineer may visit an area in which a position is to be located, and measure an RSSI value observed at an access point. When the training is performed online, the training may be performed via crowdsourcing. For example, the server may calculate positions of access points and an average measurement value of the RSSI with respect to each of the access points, based on a signal characteristic received from a mobile terminal.

The server may locate a position of the mobile terminal that entered a target area, based on the wireless signal information stored in the database, and provide position information to the mobile terminal. Alternatively, the server may provide the wireless signal information with respect to the target area to the mobile terminal that entered the target area.

Thereafter, the server collects PEI from at least one mobile terminal via crowdsourcing, in operation S12. According to an embodiment of the present disclosure, the server may request PEI from the mobile terminal, and in response to the request, the mobile terminal may transmit the PEI to the server. The server may receive a plurality of pieces of PEI transmitted from a plurality of mobile terminals. The server may also receive a signal characteristic, that is, a measured RSSI value, from the mobile terminal, and based on the received signal characteristic, may calculate the PEI of the mobile terminal. The server may collect the PEI by calculating the PEI with respect to each of the plurality of mobile terminals.

The server assesses the positioning reliability of the target area based on the collected PEI, in operation S13. The server may calculate a reliability parameter for assessing the positioning reliability, based on the PEI, and assess the positioning reliability, based on the reliability parameter.

The server determines whether to update the wireless signal information based on the assessment of the positioning reliability, in operation S14. A low positioning reliability indicates that there is a plurality of changes in an indoor wireless environment. Thus, when the positioning reliability is assessed to be low, the server may determine that it is necessary to update the wireless signal information stored in the database.

When it is determined that it is necessary to update the wireless signal information, the indoor positioning system performs re-training with respect to an indoor area, and the server updates the wireless signal information based on a signal characteristic collected via the re-training, in operation S15. The re-training may be performed online or offline, as described above.

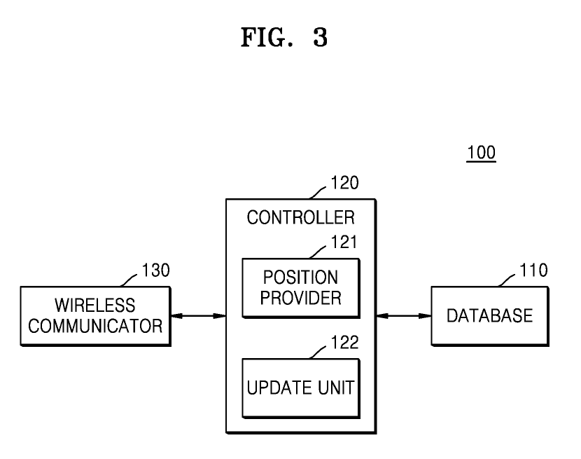

FIG. 3 is a block diagram illustrating a server, according to an embodiment of the present disclosure.

Referring to FIG. 3, the server 100 includes a wireless communicator 130, a controller 120, and the database 110. The server 100 may also include other components for locating a position.

The wireless communicator 130 may receive a signal characteristic, for example, RSSI, from the mobile terminal 200 of FIG. 1, and provide the RSSI to the controller 120. Also, the wireless communicator 130 may receive PEI from the mobile terminal 200, and provide the PEI to the controller 120. The wireless communicator 130 may transmit position information provided from the controller 120 to the mobile terminal 200.

The controller 120 may locate a position of the mobile terminal 200 and determine whether to update the database 110. To this end, the controller 120 includes a position provider 121 and an update unit 122.

The position provider 121 may locate the position of the mobile terminal 200 based on the received signal characteristic, that is, the RSSI, and the wireless signal information stored in the database 110.

The update unit 122 may determine whether it is required to update the wireless signal information stored in the database 110, based on the received PEI. In other words, the update unit 122 may determine whether to perform re-training with respect to a target area in which the position is to be located. Further, the update unit 122 may store changed wireless signal information obtained via re-training in the database 110. Alternatively, the update unit 122 may update the wireless signal information based on the signal characteristic received from the mobile terminal 200, that is, the RSSI, identification information of the access point 300, etc.

The controller 120 may be realized as a software module or a hardware module. However, the controller 120 is not limited thereto, and may be realized as a functional and/or structural combination of hardware and software for driving the hardware. For example, the controller 120 may be realized as an electronic recording medium equipped with a computer program code for performing the functions of the position provider 121 and the update unit 122, or a processor for executing the computer program code.

The database 110 may store the wireless signal information. FIG. 3 illustrates that the database 110 is included in the server 100. However, it is not limited thereto, and the database 110 may be realized as a separate device.

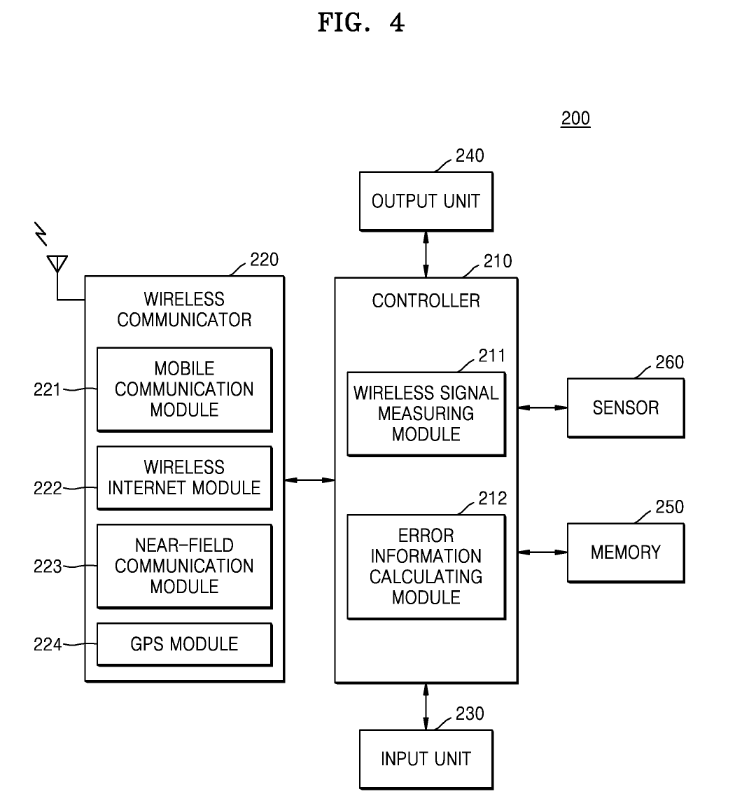

FIG. 4 is a block diagram illustrating a mobile terminal, according to an embodiment of the present disclosure.

Referring to FIG. 4, the mobile terminal 200 includes a controller 210, a wireless communicator 220, an input unit 230, an output unit 240, a memory 250, and a sensor 260. The mobile terminal 200 may also include other components in addition thereto.

The wireless communicator 220 may include at least one module enabling wireless communication between the mobile terminal 200 and a wireless communication system, between the mobile terminal 200 and another mobile terminal, or between the mobile terminal 200 and an external server. Also, the wireless communicator 220 may include at least one module connecting the mobile terminal 200 to at least one network.

The wireless communicator 220 includes at least one of a mobile communication module 221, a wireless internet module 222, a near-field communication module 223, and a GPS module 224.

The mobile communication module 221 may transmit and receive a wireless signal to and from at least one of a base station, an external terminal, and a server, in a mobile communication network established according to the technological standards or communication methods for mobile communication. For example, the communication methods may include global system for mobile communication (GSM), code division multi access (CDMA), CDMA 2000, enhanced voice-data optimized or enhanced voice-data only (EVDO), wideband CDMA (WCDMA), high speed downlink packet access (HSDPA), high speed uplink packet access (HSDPA), long term evolution (LTE), long term evolution-advanced (LTE-A), etc. The wireless signal may include data of various types according to transmission and reception of a sound signal, an image signal, or a text/multimedia message.

The wireless internet module 222 may refer to a module for wireless internet access and may be installed in the mobile terminal 200 or provided outside the mobile terminal 200. The wireless internet module 222 may transmit or receive a signal characteristic in a communication network according to wireless internet technologies.

The wireless internet technologies may include, for example, a WLAN, Wi-Fi, Wi-Fi direct, digital living network alliance (DLNA), WiBro, WiMAX, HSDPA, high speed uplink packet access (HSUPA), LTE, LTE-A, etc.

The near-field communication module 223 may perform short range communication, and may support short range communication by using, for example, at least one of Bluetooth, radio frequency identification (RFID), infrared data association (IrDA), ultra wideband (UWB), ZigBee, near fired communication (NFC), Wi-Fi, Wi-Fi direct, and wireless universal serial bus (USB).

The near-field communication module 223 may transmit and receive a wireless signal to and from at least one access point existing within a certain range. The near-field communication module 223 may collect a signal characteristic of a wireless signal received from the access point, periodically or according to an input signal of the input unit 230. Alternatively, the near-field communication module 223 may collect the signal characteristic of the wireless signal received from an adjacent access point, by being activated under control of the controller 210, when the mobile terminal 200 enters into a GPS shade area. When a local server installed in a building provides wireless signal information with respect to access points located in the building, the near-field communication module 223 may receive the wireless signal information.

The GPS module 224 may receive a GPS signal and transmit the GPS signal to the controller 210, to provide position information.

The input unit 230 may receive image information (or a signal), audio information (or a signal), data, or information input from a user. The input unit 230 may include a camera, a microphone, a touch key, a push key, etc. Sound data or image data collected by the input unit 230 may be analyzed and processed according to a control command of the user.

The output unit 240 may generate an output of the mobile terminal 200, which is related to a sense of sight, hearing, touch, etc., and may include a display, a sound output unit, a haptic module, a light output unit, etc.

The memory 250 stores data supporting various functions of the mobile terminal 200. The memory 250 may store various application programs or applications driven in the mobile terminal 200, or data and commands for an operation of the mobile terminal 200. The application programs may be stored in the memory 250, installed in the mobile terminal 200, and driven to perform the operation (or a function) of the mobile terminal 200 via the controller 210.

The sensor 260 may include at least one sensor for sensing at least one of information in the mobile terminal 200, ambient environment information surrounding the mobile terminal 200, and user information. For example, the sensor 260 may include a proximity sensor, an illumination sensor, a touch sensor, an acceleration sensor, a gyroscope sensor, a motion sensor, etc. The sensor 260 may include various sensors.

The controller 210 controls a general operation of the mobile terminal 200. The controller 210 may process a signal, data, or information input or output via other components of the mobile terminal 200, or drive the application programs stored in the memory 250.

The controller 210 includes a wireless signal measuring module 211 and an error information calculating module 212.

The wireless signal measuring module 211 may measure a signal characteristic of a wireless signal received via the wireless communicator 220. For example, the wireless signal measuring module 211 may measure the signal characteristic, such as RSSI or RTT, of the signal received via the near-field communication module 223. The signal characteristic may be provided to the server (100 of FIG. 1) via at least one of the mobile communication module 221, the wireless internet module 222, and the near-field communication module 223.

The error information calculating module 212 may calculate PEI based on the signal characteristic and information of a located position provided from the wireless signal measuring module 211. For example, the error information calculating module 212 may calculate a pathloss model error or a sample standard deviation. Also, the error information calculating module 212 may calculate a calculation value or various indices related to the pathloss model error or the sample standard deviation.

The controller 210 may further include a location positioning unit. The location positioning unit may locate a position of the mobile terminal 200 based on the measured signal characteristic and the wireless signal information received from the server 100 of FIG. 1. The controller 210 may be realized as a software module or a hardware module. However, the controller 210 is not limited thereto, and may be realized as a functional and/or structural combination of hardware and software for driving the hardware. For example, the controller 210 may be realized as an electronic recording medium equipped with a computer program code for performing the functions of the wireless signal measuring module 211 and the error information calculating module 212, or a processor for executing the computer program code.

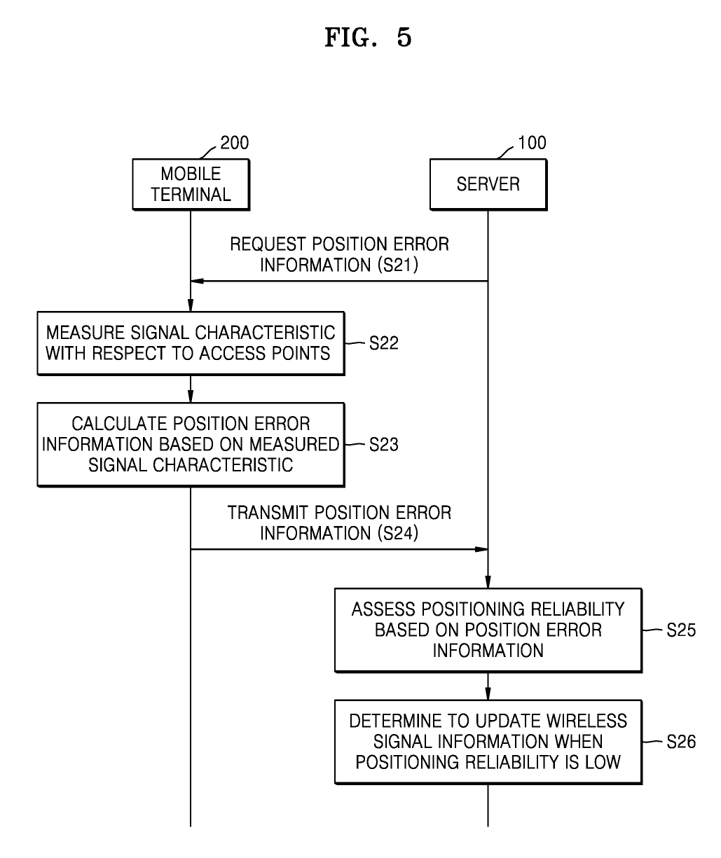

FIG. 5 is a flowchart illustrating an operation of a server and a mobile terminal, according to an embodiment of the present disclosure. In detail, FIG. 5 shows the operation of the server 100 and the mobile 200 in determining whether to update wireless signal information stored in the database.

Referring to FIG. 5, the server 100 requests PEI from the mobile terminal 200, in operation S21. The server 100 may periodically determine whether it is necessary to update the wireless signal information stored in the database, and may request the PEI from the mobile terminal 200 located in a target area, when determining with respect to an update.

In response to the request for the PEI, the mobile terminal 200 measures a signal characteristic with respect to access points, in operation S22, and calculates the PEI based on the measured signal characteristic, in operation S23. The mobile terminal 200 may measure the signal characteristic with respect to detected adjacent access points. The mobile terminal 200 may obtain a located position thereof based on the measured signal characteristic, and may calculate the PEI based on the current location and the measured signal characteristic. The current location may be a location of the mobile terminal 200 positioned by the mobile terminal 200 or the server 100 based on the measured signal characteristic.

As described above, the signal characteristic may include the RSSI or the RTT of the access points, and the PEI may include the signal propagation model error, the sample standard deviation, or a calculation value thereof. The mobile terminal 200 transmits the PEI to the server 100, in operation S24.

The server 100 assesses the positioning reliability based on the received PEI, in operation S25. The server 100 may calculate a reliability parameter for assessing the positioning reliability, based on the PEI and assess the positioning reliability based on the reliability parameter.

FIG. 5 illustrates that the server 100 receives the PEI from one mobile terminal, however, embodiments of the present disclosure are not limited thereto. The server 100 may request PEI from a plurality of mobile terminals and may assess the positioning reliability based on the PEI provided from the plurality of mobile terminals. As the number of mobile terminals providing the PEI increases, that is, as the number of pieces of PEI increases, the assessment of the positioning reliability may be more accurate.

When the positioning reliability is low, the server 100 determines to update the wireless signal information stored in the database, in operation S26. When the positioning reliability is high, the server 100 may determine that it is not requested to update the wireless signal information and may determine to retain the wireless signal information.

Operations illustrated in FIG. 5 may be periodically performed in the indoor positioning system 10, and thus, time and expenses for re-training may be minimized while quality of positioning service may be increased.

FIG. 6A is a flowchart illustrating an operation of a mobile terminal, according to an embodiment of the present disclosure. FIG. 6B is a flowchart illustrating an operation of a server, according to an embodiment of the present disclosure. The operation of the mobile terminal 200 of FIG. 6A and the operation of the server 100 of FIG. 6B relate to the operation of the mobile terminal 200 and the server 100 in FIG. 5.

Referring to FIG. 6A, the mobile terminal 200 receives a request for PEI from the server 100, in operation S110, and measures a signal characteristic with respect to adjacent access points, in operation S120, in response to the request for PEI. Thereafter, the mobile terminal 200 calculates a signal propagation model error based on the measured signal characteristics, in operation S130, respectively. Operations S22 and S23 described with reference to FIG. 5 relate to operations S120 and S130, and thus, the descriptions are provided above. As described above, the signal propagation model error indicates the difference between the signal characteristic (for example, the RSSI) estimated by using the signal propagation model and the measured signal characteristic. For example, the signal propagation model error (e) may be represented as shown in Equation (2).

$$\text{?} = \sqrt{\frac{\text{?} {\vert {φ}_{n} - {\tilde{φ}}_{n} \vert}^{2}}{\vert Θ \vert}} \\ \text{?} \text{indicates text missing or illegible when filed} \qquad ( 2 )$$

Here, n is an index of access points arranged in an area in which the mobile terminal 200 is located, φₙ is a signal characteristic of an n^{th} access point detected in the mobile terminal 200, \tilde{φ}ₙ is a signal characteristic of the n^{th} access point calculated by using the signal propagation model, Θ is an index set of access points detected in the mobile terminal 200, from among access points, and |Θ| is a size of the set Θ. For example, when a log-distance signal pathloss model is used as the signal propagation model, \tilde{φ}ₙ may be calculated according to Equation (3) below.

\tilde{φ}ₙ=αₙ−10βₙ log₁₀ dₙ (3)

Here, αₙ and βₙ are α and β of the n^{th} access point (refer to Equation (1)), respectively, and dₙ is a Euclidian distance from a point A (a current location or a located position) to the n^{th} access point, which may be represented as shown in Equation (4) below.

dₙ=\sqrt{(x_{APn}−\hat{x})²+(y_{APn}−ŷ)²} (4)

Here, (\hat{X},Ŷ) is a coordinate of the point A, and (x_{APn},y_{APn}) is a coordinate of the n^{th} access point.

When it is assumed that the log-distance propagation pathloss model is used, no access point is moved or removed, and the position location is the same as the actual location, the signal propagation model error (e) may be represented as shown in Equation (5) below.

$$e = \sqrt{\frac{\text{?} {\vert {φ}_{n} - {\tilde{φ}}_{n} \vert}^{2}}{\vert Θ \vert}} \approx \sqrt{var ( X )} \\ \text{?} \text{indicates text missing or illegible when filed} \qquad ( 5 )$$

Here, var(X) denotes a variance of noise element X of Equation 1.

In contrast, when the measured signal characteristic, for example, the RSSI, is different from a prediction value, since specific access points are moved from their original positions to far locations, the signal propagation model error (e) may be calculated according to Equation (6) below.

$$e = \sqrt{\frac{\text{?} {\vert {φ}_{n} - {\tilde{φ}}_{n} \vert}^{2} + \text{?} {\vert {φ}_{n} - {\tilde{φ}}_{n} \vert}^{2}}{\vert Θ \vert}} \geq \sqrt{\frac{\vert Θ - φ \vert var ( X )}{\vert Θ \vert} + \frac{\text{?} {\vert {\tilde{φ}}_{n} + X + {e}_{n} - {\tilde{φ}}_{n} \vert}^{2}}{\vert Θ \vert}} = \sqrt{\frac{\vert Θ - φ \vert var ( X )}{\vert Θ \vert} + \frac{\text{?} {\vert X + {e}_{n} \vert}^{2}}{\vert Θ \vert}} > \sqrt{\frac{\vert Θ - φ \vert var ( X )}{\vert Θ \vert} + \frac{\vert φ \vert var ( X )}{\vert Θ \vert}} \approx \sqrt{var ( X )} \\ \text{?} \text{indicates text missing or illegible when filed} \qquad ( 6 )$$

Here, Φ is a set of access points which are moved or removed from among the access points included in the set Θ. As shown in Equation (6), as the number of moved or removed access points increases, the value of the signal propagation model error may increase. Thus, based on the signal propagation model error, a change in the wireless environment of a corresponding area may be determined.

The mobile terminal 200 transmits the calculated signal propagation model error to the server 100, in operation S140. In other words, the mobile terminal 200 may transmit the PEI including the signal propagation model error to the server 100. According to an embodiment of the present disclosure, the PEI may include additional information, such as, for example, temporal information or spatial information related to the calculation of the signal propagation model error.

Referring to FIG. 6B, the server 100 receives the signal propagation model error from a plurality of mobile terminals, in operation S210. For example, the server 100 may receive the signal propagation model error from the plurality of mobile terminals during a specific temporal section that is set in order to assess the positioning reliability.

Thereafter, the server 100 may calculate a reliability parameter for assessing the positioning reliability with respect to the target area. The server 100 may calculate the reliability parameter based on a plurality of received signal propagation model errors.

As illustrated in FIG. 6B, the server 100 calculates an average value α_{avg} of the plurality of signal propagation model errors received from the plurality of mobile terminals, in operation S220.

The server 100 compares the average value α_{avg} with a critical value λ₁ to assess the reliability, in operation S230. The critical value λ₁ may be pre-set. The critical value λ₁ is a maximum limit of the signal propagation model error with respect to the target area. For example, the critical value λ₁ may be represented as shown in Equation (7) below.

λ₁=ηᵢ+ε (7)

Here, η₁ denotes the signal propagation model error measured by using a signal characteristic collected during training of the target area or data obtained at a point in time in which there is almost no change in the wireless environment compared to a point in time during the training. ε is a variable denoting an offset and may be set according to a characteristic of the target area.

When the average value s_{avg} is greater than the critical value λ₁, the server 100 determines that the positioning reliability is low, and determines to update the wireless signal information stored in the database, in operation S240.

When the average value s_{avg} is not greater than the critical value λ₁, the server 100 determines that the positioning reliability is high, and retains the wireless signal information stored in the database, in operation S250.

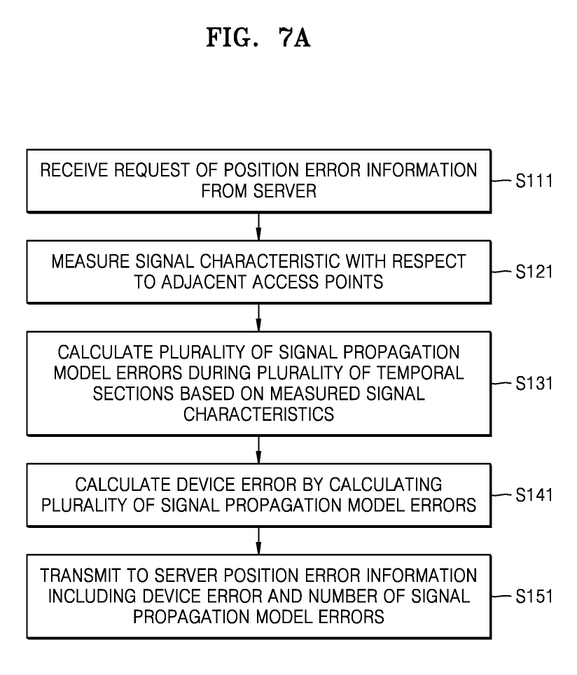

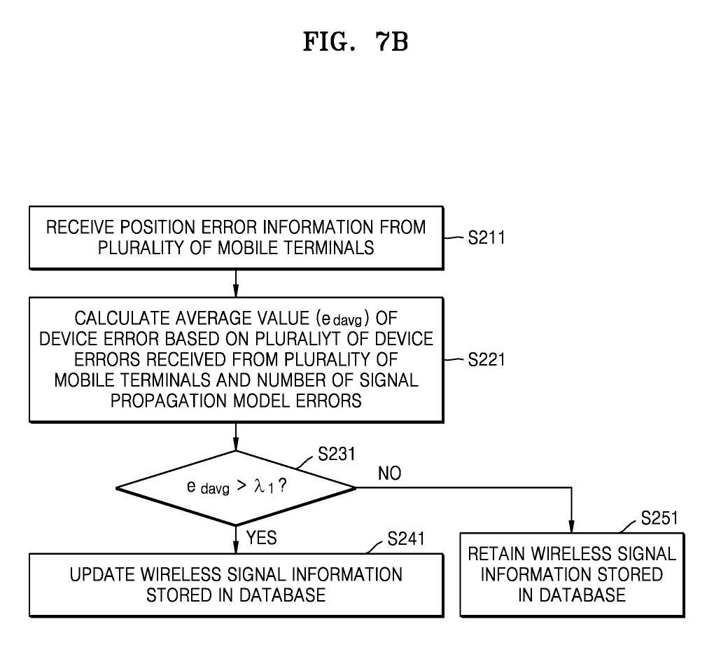

FIG. 7A is a flowchart illustrating an operation of a mobile terminal, according to an embodiment of the present disclosure. FIG. 7B is a flowchart illustrating an operation of a server, according to an embodiment of the present disclosure. The operation of the mobile terminal 200 of FIG. 7A and the operation of the server 100 of FIG. 7B relate to the operation of the mobile terminal 200 and the server 100 in FIG. 5.

Referring to FIG. 7A, the mobile terminal 200 receives a request for PEI from the server 100, in operation S111, and measures a signal characteristic with respect to adjacent access points, in operation S121.

The mobile terminal 200 calculates a plurality of signal propagation model errors during a plurality of temporal sections based on the measured signal characteristics, in operation S131. For example, when a user who owns the mobile terminal 200 is in a target area, such as a shopping mall, a location of the mobile terminal 200 may change during the plurality of temporal sections, according to the movement of the user, and thus, a located position of the mobile terminal 200 may also change. Thus, values of the plurality of signal propagation model errors calculated during the plurality of temporal sections may be different from one another. The values of the plurality of signal propagation model errors calculated in the mobile terminal 200 may reflect a general change of wireless environment of the target area.

The mobile terminal 200 calculates a signal propagation model error (hereinafter, referred to as a device error) with respect to the plurality of temporal sections, by calculating the plurality of signal propagation model errors calculated with respect to each of the temporal sections, in operation S141. For example, a device error e_{d} may be calculated according to Equation 8 below.

s_{d}=Σⱼ₌₁^{N}^{ₜ}(e(j))² (8)

Here, e(j) is a signal propagation model error calculated in a j^{th} temporal section, and Nₜ is the number of temporal sections in which the plurality of signal propagation model errors are calculated, that is, the number of signal propagation model errors.

The mobile terminal 200 transmits the PEI including the calculated device error and the number of signal propagation model errors used in calculating the device error, to the server 100, in operation S151.

Referring to FIG. 7B, the server 100 receives the PEI from a plurality of mobile terminals, in operation S211. The PEI may include the device error calculated in a corresponding mobile terminal and the number of signal propagation model errors used in calculating the device error.

The server 100 may calculate an average value e_{davg} of the device error, based on a plurality of device errors received from the plurality of mobile terminals and the number of signal propagation model errors, in operation S221. For example, the average value e_{davg} of the device error may be calculated according to Equation 9 below.

$$\text{?} = \frac{\text{?}}{\text{?}} \\ \text{?} \text{indicates text missing or illegible when filed} \qquad ( 9 )$$

Here, e_{dk} and Nₜₕ indicate the device error and the number of signal propagation model errors received from the mobile terminal. K is the number of mobile terminals transmitting the PEI.

The server 100 compares the average value e_{davg} of the device error with a predetermined critical value λ₁ to assess the reliability, in operation S231.

When the average value e_{davg} of the device error is greater than the critical value λ₁, the server 100 determines that the positioning reliability is low, and updates the wireless signal information stored in the database, in operation S241.

When the average value e_{davg} of the device error is not greater than the critical value the server 100 determines that the positioning reliability is high, and retains the wireless signal information stored in the database, in operation S251.

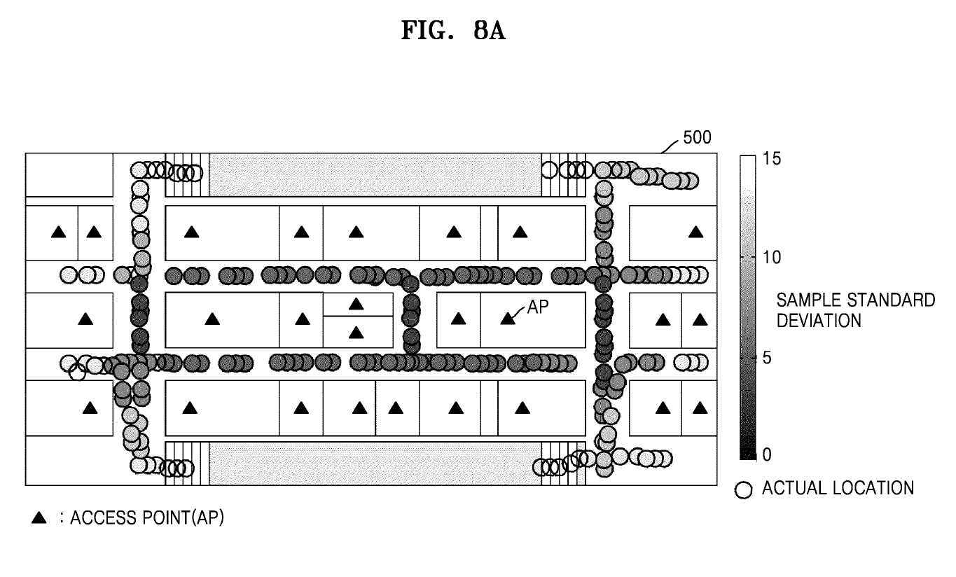

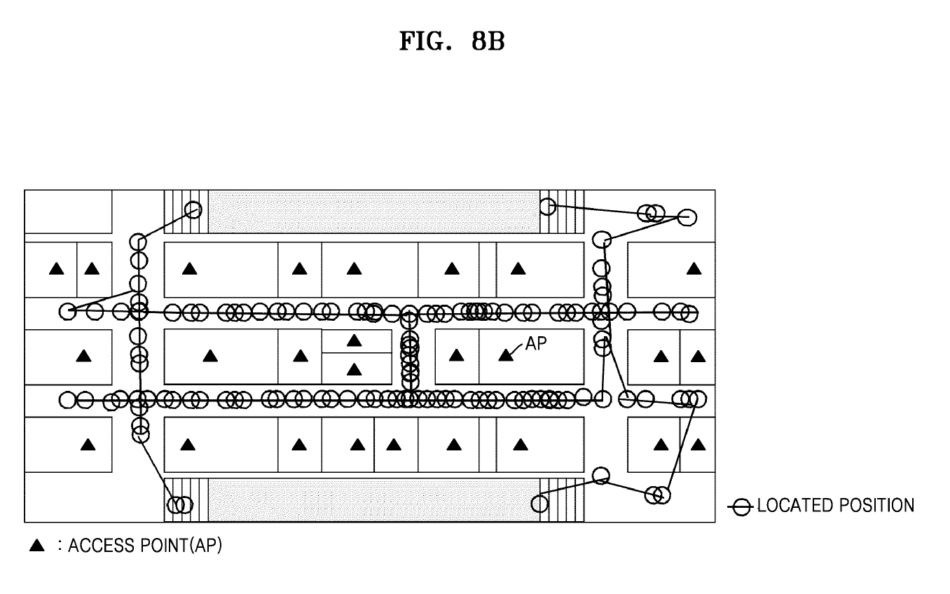

FIGS. 8A and 8B are diagrams illustrating an accuracy of a located position according to a sample standard deviation. FIG. 8A shows an actual location of a mobile terminal in a target area, that is, an actual location to which the mobile terminal moves, and the sample standard deviation measured at each location. FIG. 8B shows the located position of the mobile terminal.

Referring to FIG. 8A, a plurality of access points APs are located at a plurality of points of a building 500. As the sample standard deviation decreases, the actual location is indicated less darkly. It is shown that the sample standard deviation increases at a location where the number of adjacent access points AP decreases from among the actual locations of a user of the mobile terminal according to the movement of the mobile terminal. Also, when comparing the actual location of FIG. 8A with the located position of FIG. 8B, it is shown that the positioning is not performed accurately in the location where the sample standard deviation is high. Thus, the reliability of the currently located position may be determined based on the sample standard deviation.

The signal propagation model error may reflect a change in wireless environment well when the located position is accurate. Thus, the device error may be calculated based on the signal propagation model error calculated in the location where it is determined that a difference between the located position based on the sample standard deviation and the actual location is not big, in order to increase the reliability of the device error. An operation of the mobile terminal according to the method described above is described in detail below with reference to FIG. 9.

FIG. 9 is a flowchart illustrating the operation of a mobile terminal, according to an embodiment of the present disclosure. The operation of the mobile terminal of FIG. 9 is related to the operation of the mobile terminal 200 in FIG. 5.

Referring to FIG. 9, the mobile terminal 200 receives a request for PEI from the server 100, in operation S112, and measures a signal characteristic with respect to adjacent access points, in operation S122.

The mobile terminal 200 calculates a plurality of signal propagation model errors and a plurality of sample standard deviations during a plurality of temporal sections based on the measured signal characteristics, in operation S132. In other words, the mobile terminal 200 may calculate the signal propagation model error and the sample standard deviation for each temporal section, based on the signal characteristic measured for each temporal section during the plurality of temporal sections. The number of signal propagation model errors and the number of sample standard deviations may be the same.

The mobile terminal 200 may assign a probability value to each of candidate points received from the server 100 or randomly generated, and calculate the sample standard deviation D according to Equation 10 below.

$$\text{?} = \sqrt{( \text{?} {w}_{i} {x}_{i}^{2} - {( \text{?} {w}_{i} {x}_{i} )}^{2} ) + ( \text{?} {w}_{i} {y}_{i}^{2} - {( \text{?} {w}_{i} {y}_{i} )}^{2} )} \\ \text{?} \text{indicates text missing or illegible when filed} \qquad ( 10 )$$

Here, L is the number of candidate points, (xᵢ,yᵢ) is a coordinate of an i^{th} candidate point, and is a probability value satisfying Σᵢ₌₁wᵢ=1.

The candidate points and the probability value assigned to the candidate points may be determined based on the signal characteristic measured by the mobile terminal 200. For example, the server 100 or the mobile terminal 200 may determine the candidate points and assign the probability value to the candidate points based on an RSSI value measured by the mobile terminal 200.

The mobile terminal 200 calculates at least one signal propagation model error from among the plurality of signal propagation model errors, which has a corresponding sample standard deviation, which is less than a pre-set reference value, to calculate the device error, in operation S142. For example, the plurality of signal propagation models errors and sample standard deviations are calculated at each of first through tenth temporal sections, and when the sample standard deviation calculated at the first through eighth temporal sections is less than a reference value, the mobile terminal 20 may calculate the signal propagation model error calculated at the first through eighth temporal sections to calculate the device error.

The mobile terminal 200 may calculate the device error e_{ds} reflecting the sample standard deviation according to Equation (11).

e_{ds}=Σ_{j-1,P}^{N}^{ₜ}(e(j))² (11)

Here, D(j) is a sample standard deviation calculated by using Equation 4 at a j^{th} temporal section, and λ₂ may be a reference value with respect to a pre-set sample standard deviation. For example, λ₂ may be a threshold value of the sample standard deviation.

The mobile terminal 200 transmits the PEI including the device error and the number of signal propagation model errors used in calculating the device error to the server 100, in operation S152.

Here, the server 100 may calculate an average value of the device error according to the method described with reference to FIG. 7B. The server 100 may calculate the average value of the device error, based on the plurality of device errors and the number of signal propagation model errors that are received.

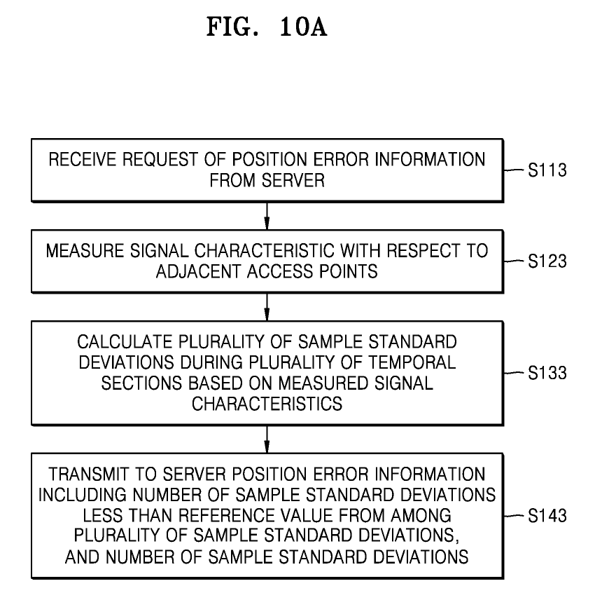

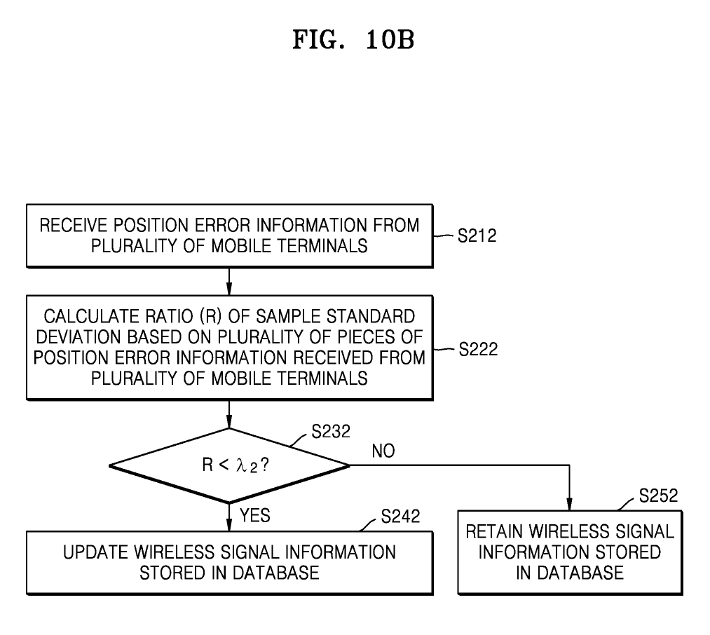

As described above, the reliability of the currently located position may be determined based on the sample standard deviation, and thus, the positioning reliability of the target area may be determined based on the sample standard deviation. Referring to FIGS. 10A, and 10B, an operation of the mobile terminal 200 and the server 100 for assessing the positioning reliability based on the sample standard deviation and determining whether to update the wireless signal information are described.

FIG. 10A is a flowchart illustrating the operation of a mobile terminal, according to an embodiment of the present disclosure. FIG. 10B is a flowchart illustrating the operation of a server, according to an embodiment of the present disclosure. The operation of the mobile terminal of FIG. 10A and the operation of the server of FIG. 10B relate to the operation of the mobile terminal 200 and the server 100 of FIG. 5.

Referring to FIG. 10A, the mobile terminal 200 receives a request for PEI from the server 100, in operation S113, and measures a signal characteristic with respect to adjacent access points, in operation S123.

The mobile terminal 200 calculates a plurality of sample standard deviations during a plurality of temporal sections based on the measured signal characteristics, in operation S133.

The mobile terminal 200 calculates the number of sample standard deviations from among the plurality of sample standard deviations, which are less than a pre-set reference value, and transmits the PEI including the number of sample standard deviations that are less than the reference value and the number of sample standard deviations to the server 100, in operation S143. The PEI may include the plurality of sample standard deviations.

Referring to FIG. 10B, the server 100 receives the PEI from a plurality of mobile terminals, in operation S212. The PEI received from each of the plurality of mobile terminals may include the number of sample standard deviations calculated in corresponding mobile terminals and the number of sample standard deviations from among the plurality of sample standard deviations, which are less than the reference value. The PEI may include the plurality of sample standard deviations calculated in the mobile terminal.

The server 100 may calculate a ratio R of the sample standard deviation based on a plurality of pieces of position error information received from the plurality of mobile terminals, in operation S222. The ratio R of the sample standard deviation may denote a quality factor of the total sample standard deviations calculated with respect to a target area.

For example, the server 100 may calculate the ratio R of the sample standard deviation according to Equation (12) below.

$$R = \frac{{N}_{nom}}{{N}_{denom}} \qquad ( 12 )$$

Here, Nₙₒₘ is a sum of the number of sample standard deviations received from the plurality of mobile terminals, and N_{denom} is a sum of the number of sample standard deviations which are less than the reference value, received from the plurality of mobile terminals.

In operation S232, the server determines whether the ratio R of the sample standard deviation is less than the reference value λ₂. When the ratio R of the sample standard deviation is less than the reference value λ₂, the server 100 determines that the positioning reliability is low, and updates the wireless signal information stored in the database, in operation S242. The reference value λ₂ may be pre-set.

When the ratio R of the sample standard deviation is not less than the reference value λ₂, the server 100 determines that the positioning reliability is high and retains the wireless signal information stored in the database, in operation S252.

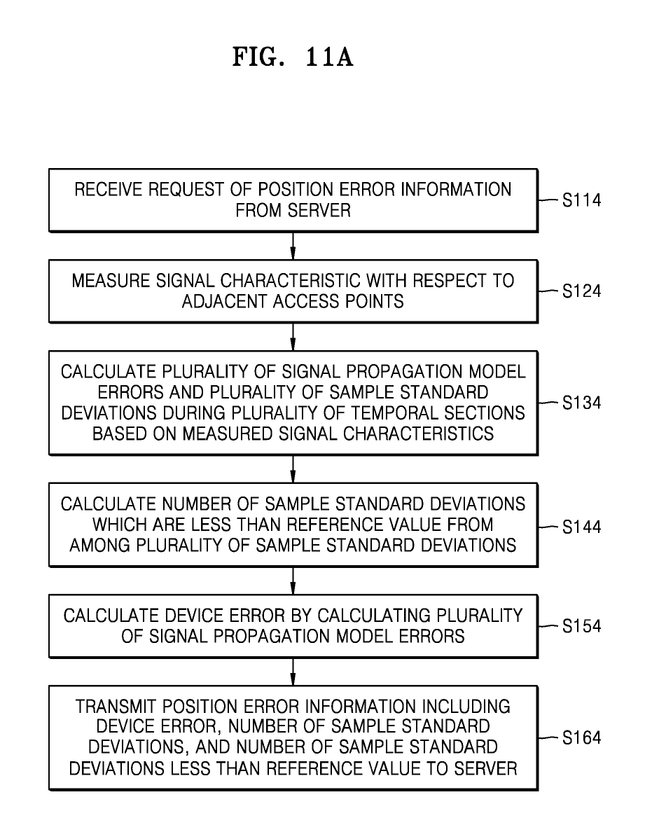

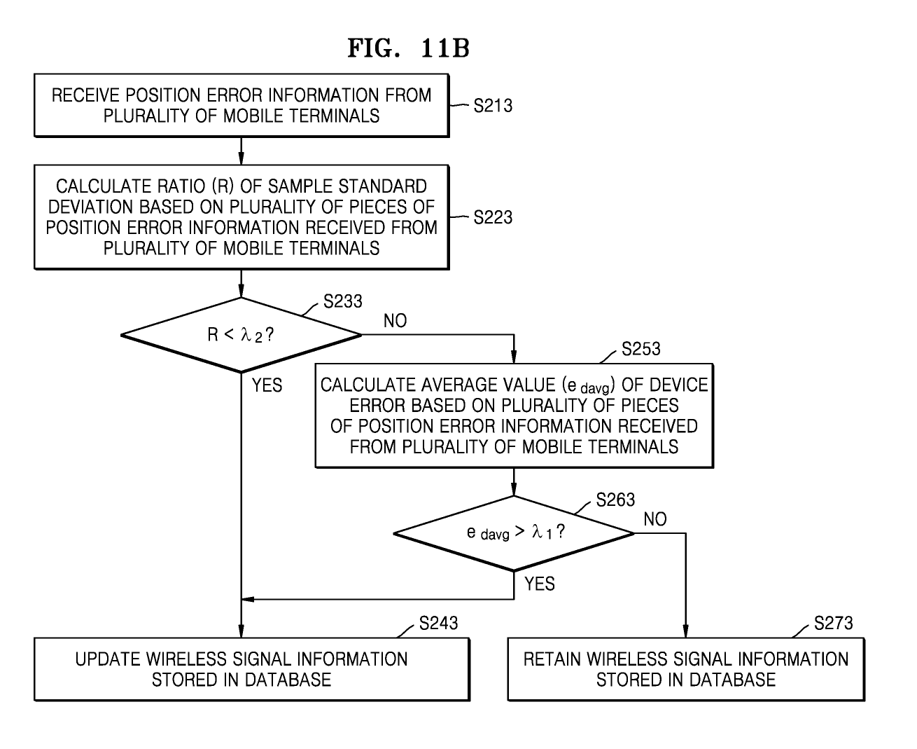

FIG. 11A is a flowchart illustrating an operation of a mobile terminal, according to an embodiment of the present disclosure. FIG. 11B is a flowchart of an operation of a server, according to an embodiment of the present disclosure. The operation of the mobile terminal of FIG. 11A and the operation of the server of FIG. 11B are related to the operation of the mobile terminal 200 and the server 100 of FIG. 5.

Referring to FIG. 11A, the mobile terminal 200 receives a request for PEI from the server 100, in operation S114, and measures a signal characteristic with respect to adjacent access points, in operation S124.

Thereafter, the mobile terminal 200 calculates a plurality of signal propagation model errors and a plurality of sample standard deviations during a plurality of temporal sections, based on the measured signal characteristics, in operation S134.

The mobile terminal 200 calculates the number of sample standard deviations, which are less than a reference value, from among the plurality of sample standard deviations, in operation S144. Also, the mobile terminal 200 calculates the plurality of signal propagation model errors to calculate a device error, in operation S154. The device error may be calculated according to Equation (8).

The mobile terminal 200 transmits the PEI including the device error, the number of sample standard deviations, and the number of the sample standard deviations which are less than the reference value to the server 100, in operation S164.

Referring to FIG. 11B, the server 100 receives the PEI from a plurality of mobile terminals, in operation S213. The PEI may include the number of sample standard deviations, the number of the sample standard deviations which are less than the reference value, and the device error, calculated in the corresponding mobile terminals

The server 100 calculates a ratio R of the sample standard deviation based on a plurality of pieces of position error information. As described above with reference to FIG. 10B, the server 100 calculates the ratio R of the sample standard deviation according to Equation (11), in operation S223.

The server 100 compares the ratio R of the sample standard deviation with a reference value λ₂, in operation S233.

When the ratio R of the sample standard deviation is less than the reference value λ₂, the server 100 determines that a positioning reliability is low, and updates the wireless signal information stored in the database, in operation S243.

When the ratio R of the sample standard deviation is not less than the reference value λ₂, the server 100 determines a positioning reliability based on the signal propagation model error.

The server 100 calculates an average value e_{davg} of the device error based on the plurality of pieces of error information received from the plurality of mobile terminals. As described above with reference to FIG. 6A, the server 100 calculates the average value e_{davg} of the device error according to Equation (9), in operation S253. The operation S253 of calculating the average value of the device error may be performed before or simultaneously with the operation S223 of calculating the ratio of the sample standard deviation.

The server 100 compares the average value e_{davg} of the device error with a pre-set critical value λ₁, in operation S263.

When the average value e_{davg} of the device error is greater than the critical value λ₁, the server 100 determines that the positioning reliability is low and updates the wireless signal information stored in the database, in operation S243.

When the average value e_{davg} of the device error is not greater than the critical value λ₁, the server 100 determines that the positioning reliability is high and retains the wireless signal information stored in the database, in operation S273.

As such, the server 100 may determine the positioning reliability of a target area by using the signal propagation model error and the sample standard deviation and determine an update of the wireless signal information.

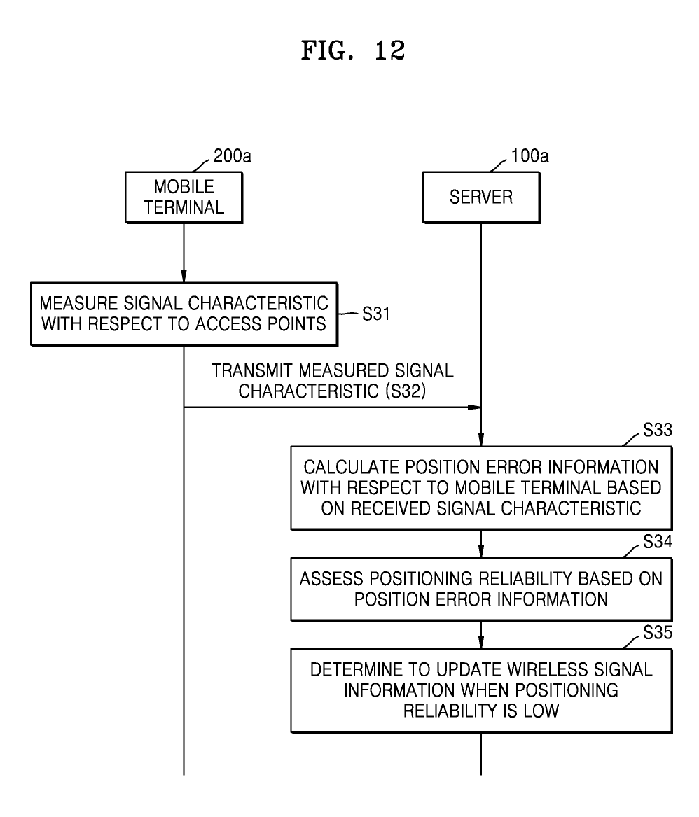

FIG. 12 is a flowchart illustrating an operation of a server and a mobile terminal, according to an embodiment of the present disclosure. In detail, FIG. 12 shows the operation of a server 100a and a mobile terminal 200a for determining whether to update wireless signal information stored in a database.

In FIG. 5, the mobile terminal 200 calculates the position error information in response to a request of the server 100 and provides the calculated position error information to the server 100. However, according to the embodiment of FIG. 12, the server 100a calculates position error information with respect to the mobile terminal 200a based on data provided from the mobile terminal 200a, and assesses the positioning reliability by using the calculated position error information.

Referring to FIG. 12, the mobile terminal 200a measures a signal characteristic with respect to access points, in operation S31, and transmits the measured signal characteristic to the server 100a, in operation S32. The mobile terminal 200a may periodically measure the signal characteristic and transmit the measured signal characteristic to the server 100a.

The server 100a may locate a position of the mobile terminal 200a based on the signal characteristic and provide position information with respect to the located position to the mobile terminal 200a.

The server 100a calculates the PEI with respect to the mobile terminal 200a based on the received signal characteristic, in operation S33. The server 100a may locate the position of the mobile terminal 200a based on the signal characteristic and calculate the PEI based on the located position. For example, the PEI may include a signal propagation model error, a sample standard deviation, or a calculation value thereof. The method of calculating the signal propagation model error, the sample standard deviations, or the calculation value thereof described with reference to FIGS. 6A, 7A, 9, 10A, and 11A may be applied to the operation S33 of calculating the position error information via the server 100a according to the present embodiment.

The server 100a may periodically determine whether it is necessary to update the wireless signal information stored in the database and may calculate the position error information based on the signal characteristic, received from the mobile terminal 200a at a point of determining an update.

FIG. 12 illustrates that the server 100a receives the PEI from one mobile terminal. However, this is only for convenience of explanation, and embodiments are not limited thereto. The server 100a may receive the signal characteristic from a plurality of mobile terminals and calculate the PEI with respect to each of the plurality of mobile terminals. Also, the server 100a may calculate the PEI with respect to the target area based on the signal characteristic received from the plurality of mobile terminals.

Thereafter, the server 100a assesses the positioning reliability based on the PEI, in operation S34, and updates the wireless signal information stored in the database, when the positioning reliability is low, in operation S35. The method of assessing the positioning reliability described with reference to FIGS. 6B, 7B, 10B, and 11B may be applied to the operation S34 of assessing the positioning reliability via the server 100a. The operation S34 of assessing the positioning reliability and the operation S35 of updating the wireless signal information are substantially the same as the operation S25 of assessing the positioning reliability and the operation S26 of updating the wireless signal information, described in FIG. 5.

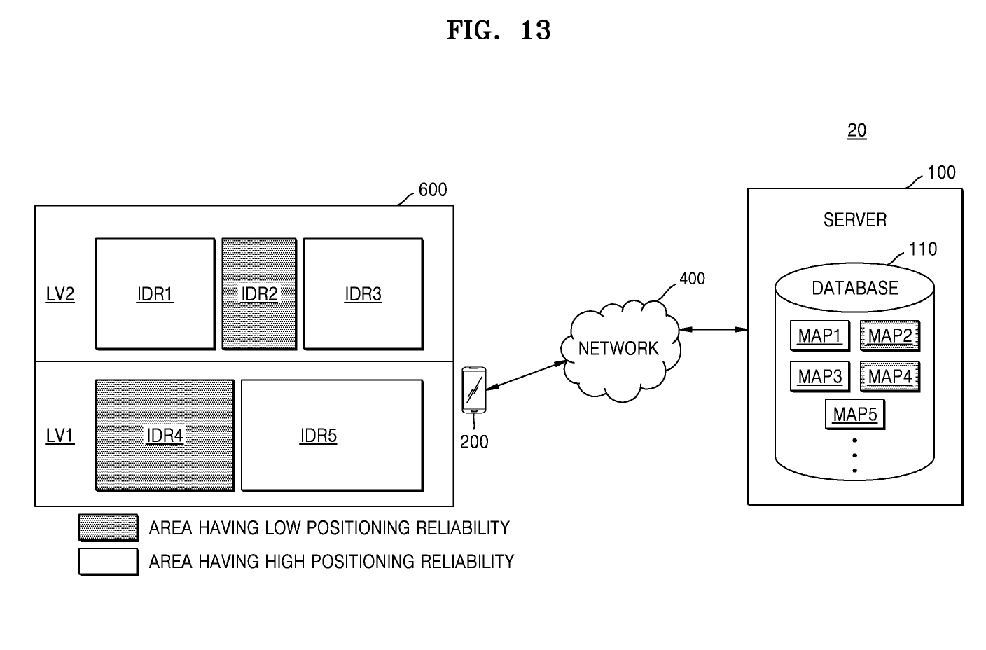

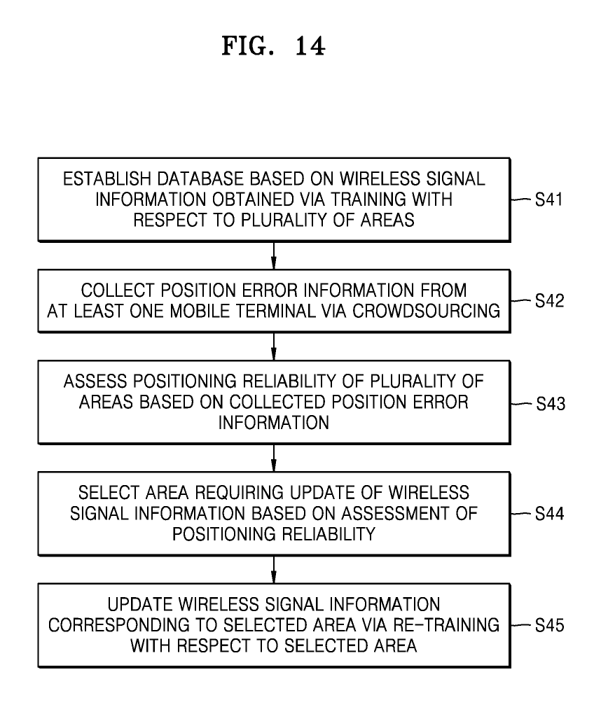

FIG. 13 is a diagram illustrating an operating method of an indoor positioning system, according to an embodiment of the present disclosure. FIG. 14 is a flowchart illustrating an operating method of the indoor positioning system of FIG. 13, according to an embodiment of the present disclosure. In detail, FIGS. 13 and 14 show processes of establishing and updating the database 110 of the indoor positioning system 20 providing a positioning service with respect to a plurality of areas.

Referring to FIGS. 13 and 14, the indoor positioning system 20 may establish the database 110 based on a plurality of pieces of wireless signal information obtained via training with respect to a plurality of areas IDR1 through IDR5, in operation S41. For example, the wireless signal information may be stored as a data map type, and the database 110 may store first through fifth data maps MAP1 through MAP5 with respect to the first through fifth areas IDR1 through IDR5.

FIG. 13 illustrates that the plurality of areas IDR1 through IDR5 are areas in a building 600, however, embodiments of the present disclosure are not limited thereto. The plurality of areas IDR1 through IDR5 may be a plurality of areas for which the indoor positioning system 20 provides a positioning service. For example, the plurality of areas may be a plurality of areas located in different floors (for example, a first floor LV1 and a second floor LV2) in a building, may be a plurality of areas located in different buildings, or may be a plurality of areas located remotely from one another.

The server 100 may locate a position of the mobile terminal 200, which entered into the first through fifth areas IDR1 through IDR5, based on the wireless signal information stored in the database 110, and provide position information to the mobile terminal 200.

Thereafter, the server 100 collects PEI from at least one mobile terminal 200 via crowdsourcing, in operation S42. The server 100 may collect the PEI with respect to each area. The operation S42 of collecting the PEI is substantially the same as the operation S12 in FIG. 2.

The server 100 assesses the positioning reliability with respect to each of a plurality of areas based on the collected PEI, in operation S43. The server 100 may calculate a reliability parameter for assessing the positioning reliability based on the PEI, and compare the reliability parameter with a pre-set critical value to assess the positioning reliability. Here, since wireless environment of each of the areas is different, the critical value pre-set with respect to each area may be different from one another.

The server 100 selects an area for which updating of wireless signal information is required, based on the assessment of the positioning reliability, in operation S44. In other words, the server 100 may determine to update the wireless signal information corresponding to the area having a low positioning reliability.

For example, referring to FIG. 13, when the positioning reliability of the second area IDR2 and the fourth area IDR4 is assessed to be low, the server 100 may determine an update with respect to the second data map MP2 and the fourth data map MAP4 corresponding to the second area IDR2 and the fourth area IDR4.

Thereafter, the indoor positioning system 20 performs re-training with respect to the selected area and the server 100 may update the wireless signal information corresponding to the selected area based on a signal characteristic collected via the re-training, in operation S45.

For example, the re-training with respect to the second area IDR2 and the fourth area IDR4 may be performed, and the server 100 may update the second data map MAP2 and the fourth data map MP4 based on the signal characteristic collected via the re-training.

The indoor positioning system 20 may perform re-training and update the database, only with respect to the area for which it is estimated that there is a great change in wireless environment, and thus, time and expenses taken for an update of the database may be reduced.

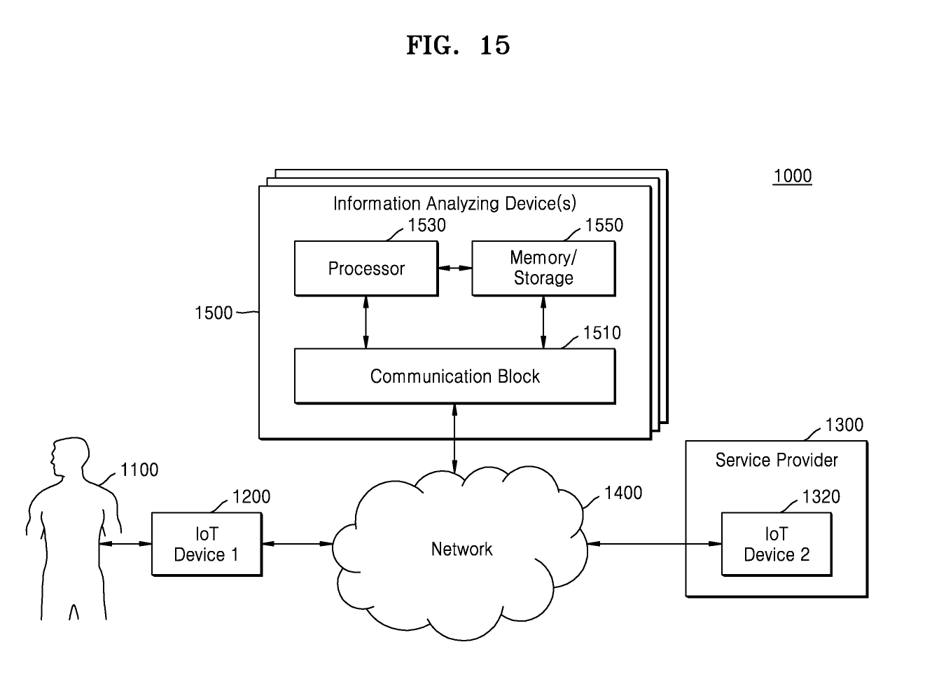

FIG. 15 is a diagram illustrating a structure of a service system providing a location-based service to a user, according to an embodiment of the present disclosure.

Referring to FIG. 15, a service system 1000 includes a user 1100, a first internet of things (IoT) device 1200, a service provider 1300, a network 1400, and an information analyzing device 1500.

The user 1100 may request at least one location-based service. The user 1100 may actively request the service by using the first IoT device 1200 and receive the requested service. Alternatively, the user 1100 may inactively receive the service according to an operation of the first IoT device 1200. The first IoT device 1200 may include at least one of a mobile electronic device, such as, for example, a smart phone, a tablet personal computer (PC), etc., and a wearable device, such as a watch, glasses, etc.

The service provider 1300 may provide the location-based service to the user 1100. For example, the service provider 1300 may provide at least one of various types of services, such as, for example, a medical service, a broadcasting service, and an educational service, to the user 1100, however, embodiments of the present disclosure are not limited thereto. The service provider 1300 may include one provider or a plurality of providers.

The service provider 1300 may provide the service to the user 1100 via a second IoT device 1320. For example, when the service request of the first IoT device 1200 is transmitted to the service provider 1300 via the network 1400, the service provider 1300 may provide the service corresponding to the request to the user 1100 via the network 1400 by using the second IoT device 1320.

In FIG. 15, each of the first IoT device 1200 and the second IoT device 1320 is directly connected to the network 1400. Alternatively, each of the first IoT device 1200 and the second IoT device 1320 may be connected to the network 1400 via an access point and a gateway, respectively. Further, various data may be directly exchanged between the first IoT device 1200 and the second IoT device 1320. Alternatively, data exchanged between the first IoT device 1200 and the second IoT device 1320 may be transmitted to each other via a distributed server system or the information analyzing device 1500. An embodiment of the present disclosure may be altered or corrected in various ways.

The information analyzing device 1500 may analyze information to provide the service. In particular, the information analyzing device 1500 may analyze the information necessary to achieve an objective of the service. The information analyzing device 1500 may include the servers 100 and 100a. The information analyzing device 1500 may include a database including wireless signal information for indoor positioning. The information analyzing device 1500 may receive a signal characteristic of a signal received from an adjacent access point, from the first IoT device 1200, and position a location of the first IoT device 1200 based on the signal characteristic. When the first IoT device 1200 enters into a specific area, for example, an indoor area, the information analyzing device 1500 may provide wireless signal information with respect to the area, from among wireless signal information stored in a database, to the first IoT device 1200. The first IoT device 1200 may store the received wireless signal information and may locate the position thereof based on the wireless signal information.

The information analyzing device 1500 may output a result necessary for providing the positioning service. The output result may be transmitted to the user 1100 and/or the service provider 1300. For example, the information analyzing device 1500 may transmit information about the located position to the user 1100 and/or the service provider 1300.

Also, the information analyzing device 1500 may receive PEI from the first IoT device 1200 (or a plurality of first IoT devices), assess a positioning reliability with respect to an area in which the first IoT device 1200 is located, based on the PEI, and determine whether to perform re-training with respect to the area based on a result of the assessment. The information analyzing device 1500 may update the wireless signal information stored in the database based on information obtained via the re-training. The information analyzing device 1500 may locate a position of the first IoT device 1200 based on the updated wireless signal information or provide the updated wireless signal information to the first IoT device 1200.

The information analyzing device 1500 may include a general-purpose computer, such as a personal computer, and/or a special purpose computer, such as a workstation. The information analyzing device 1500 may include one or more computing devices. For example, the information analyzing device 1500 may include a communication block 1510, a processor 1530, and a memory/storage 1550.

The communication block 1510 may be used to communicate with the IoT devices (for example, the first IoT device 1200) via the network 1400. The communication block 1510 may receive information and data from the network 1400. Alternatively, the communication block 1510 may transmit a result necessary for providing a service to the user 1100 via the network 1400.

The processor 1530 may process the received information and data and output the result necessary for providing the service. The processor 1530 may perform arithmetic calculations and/or logic calculations necessary for performing the operations according to the embodiments. The memory/storage 1550 may temporarily or semi-permanently store the data processed or to be processed by the processor 1530.

While the present disclosure has been shown and described with reference to certain embodiments thereof, it will be understood that various changes in form and detail may be made therein without departing from the spirit and scope of the present disclosure as defined by the following claims.

What is claimed is:

1. A method of managing wireless signal information for positioning a mobile terminal, via a server, the method comprising:
storing, in a database, the wireless signal information obtained by measuring a signal characteristic with respect to access points of a target area;
receiving, from at least one mobile terminal, at least one piece of position error information calculated based on the wireless signal information;
assessing a positioning reliability with respect to the target area, based on the at least one piece of position error information; and
determining whether to update the wireless signal information, based on the assessed position reliability.

2. The method of claim 1, wherein:
each piece of position error information comprises a signal propagation model error with respect to one or more access points detected in a respective mobile terminal, from among the access points of the target area; and
the signal propagation model error indicates a difference between a signal characteristic measurement value and a signal characteristic estimation value with respect to a located position of the respective mobile terminal.

3. The method of claim 2, wherein the signal propagation model error (e) is calculated according to:
$$e = \sqrt{\frac{\text{?} {\vert {φ}_{n} - {\tilde{φ}}_{n} \vert}^{2}}{\vert Θ \vert}}$$
$$\text{?} \text{indicates text missing or illegible when filed}$$
wherein n is an index of the access points φₙ is a signal characteristic measurement value of an n^{th} access point detected in the respective mobile terminal, \tilde{φ}ₙ is a signal characteristic estimation value of the n^{th} access point, calculated based on a signal propagation model, Θ is an index set of the one or more access points detected in the respective mobile terminal, and |Θ| indicates a size of the index set Θ.

4. The method of claim 2, wherein the signal characteristic comprises at least one of a received signal strength indicator (RSSI) and a round trip time (RTT) of a received signal.

5. The method of claim 2, wherein:
a plurality of signal propagation models and a plurality of sample standard deviations according to a plurality of temporal sections are calculated in the respective mobile terminal; and
the each piece of position error information comprises at least one signal propagation model error having a corresponding sample standard deviation, which is less than a reference value, from among the plurality of signal propagation models.

6. The method of claim 1, wherein each piece of position error information is calculated based on a sample standard deviation according to a located position of a respective mobile terminal.

7. The method of claim 6, wherein the sample standard deviation (D) is calculated according to:
$$D - \sqrt{( \text{?} {w}_{i} {x}_{i}^{2} - {( \text{?} {w}_{i} {x}_{i} )}^{2} ) + ( \text{?} {w}_{i} {y}_{i}^{2} - {( \text{?} {w}_{i} {y}_{i} )}^{2} )} , \\ \text{?} \text{indicates text missing or illegible when filed}$$
wherein L is a number of candidate positions of the respective mobile terminal, (xᵢ,yᵢ) is a coordinate of an i^{th} candidate position from among the candidate positions, and wᵢ is a probability value assigned to the i^{th} candidate position.

8. The method of claim 1, wherein
the at least one piece of position error information comprises a plurality of pieces of position error information, and the at least one mobile terminal comprises a plurality of mobile terminals; and
wherein assessing the positioning reliability comprises:
calculating a reliability parameter with respect to positioning based on the plurality of pieces of position error information; and
comparing the reliability parameter with a pre-set critical value.

9. The method of claim 8, wherein:
the plurality of pieces of position error information comprise a plurality of signal propagation model errors calculated in the plurality of mobile terminals, and
calculating the reliability parameter comprises calculating an average value of the plurality of signal propagation model errors.

10. The method of claim 8, wherein:
the plurality of pieces of position error information comprise a number of sample standard deviations calculated in the plurality of mobile terminals and a number of sample standard deviations that are less than a reference value; and
calculating the reliability parameter comprises calculating a ratio of the sample standard deviations to the sample standard deviations that are less than the reference value.

11. The method of claim 8, wherein:
the plurality of pieces of position error information comprise a plurality of signal propagation model errors calculated in the plurality of mobile terminals, a number of sample standard deviations, and a number of sample standard deviations that are less than a reference value;
calculating the reliability parameter comprises:
calculating an average value of the plurality of signal propagation model errors; and
calculating a ratio of the sample standard deviations to the sample standard deviations that are less than the reference value; and
comparing the reliability parameter with the pre-set critical value comprises:
comparing the calculated ratio with a first critical value; and
comparing the calculated average value with a second critical value.

12. The method of claim 1, wherein:
the database stores a plurality of pieces of wireless signal information with respect to a plurality of target areas; and
assessing the positioning reliability and determining whether to update the wireless signal information are performed with respect to each of the plurality of target areas.

13. An operating method of a positioning server, the method comprising:
receiving at least one signal characteristic measurement value from at least one mobile terminal located in a target area;
calculating at least one piece of position error information with respect to the at least one mobile terminal based on the at least one signal characteristic measurement value and wireless signal information stored in a database;
assessing a positioning reliability with respect to the target area based on the at least one piece of position error information; and
determining whether to update the database based on the assessed positioning reliability.

14. The operating method of claim 13, wherein each of the at least one piece of position error information comprises a signal propagation model error with respect to a located position of a respective mobile terminal, which is estimated based on a respective signal characteristic measurement value and the wireless signal information.

15. The operating method of claim 13, wherein each of the at least one piece of position error information comprises a standard deviation with respect to candidate positions selected based on a respective signal characteristic measurement value.

16. An operating method of a mobile terminal, the method comprising:
receiving a request for position error information from a server;
measuring signal characteristics with respect to one or more access points detected by the mobile terminal from among a plurality of access points in a target area;
calculating the position error information based on the measured signal characteristics; and
transmitting the position error information to the server.

17. The operating method of claim 16, wherein:
the position error information comprises a signal propagation model error with respect to the one or more access points; and
the signal propagation model error indicates a difference between a signal characteristic measurement value and a signal characteristic estimation value with respect to a located position of the mobile terminal.

18. The operating method of claim 17, wherein the signal characteristics comprise at least one of a received signal strength indicator (RSSI) and a round trip time (RTT) of a received signal.

19. The operating method of claim 17, wherein:
calculating the position error information comprises calculating a plurality of signal propagation models and a plurality of sample standard deviations according to a plurality of temporal sections; and
the position error information comprises at least one signal propagation model error having a corresponding sample standard deviation, which is less than a reference value, from among the plurality of signal propagation models.

20. The operating method of claim 16, wherein the position error information is calculated based on a sample standard deviation according to a located position of the mobile terminal.
